(19) United States
(12) Patent Application Publication
(10) Pub. No.: US 2025/0304001 A1
(43) Pub. Date: Oct. 2, 2025

(54) SYSTEM AND METHOD FOR CONTROLLING A VEHICLE FROM OUTSIDE THE VEHICLE

(71) Applicants: HYUNDAI MOTOR COMPANY, Seoul (KR); KIA CORPORATION, Seoul (KR)

(72) Inventors: Huanjun Zheng, Yantai (CN); Yu Ting Wu, Yantai (CN); Ai Mei Sheng, Yantai (CN); Wenzhe Li, Yantai (CN); Shuo Yang, Yantai (CN); Jialing Zhang, Yantai (CN)

(73) Assignees: HYUNDAI MOTOR COMPANY, Seoul (KR); KIA CORPORATION, Seoul (KR)

(21) Appl. No.: 19/088,595

(22) Filed: Mar. 24, 2025

(30) Foreign Application Priority Data
Mar. 27, 2024 (CN) 202410361270.9

(51) Int. Cl. B60R 25/01; B60R 25/24; B60R 25/25; G10L 21/0208

(52) U.S. Cl. CPC B60R 25/01; B60R 25/24; B60R 25/257; G10L 21/0208; G10L 2021/02082

(57) ABSTRACT

A system for controlling a vehicle from outside the vehicle includes a voice receiving device, a first safety detection device, a second safety detection device, and a voice control device. The first safety detection device may recognize a vehicle user by using a mobile device associated with the vehicle user, and determine that a first safety condition is satisfied when the mobile device is approaching the vehicle. The second safety detection device may determine that a second safety condition is satisfied when a voiceprint of voice information received from the voice receiving device matches a pre-stored voiceprint. The voice control device may be switched from a sleep state to a wake-up state when the first safety condition is satisfied, control the voice receiving device to receive the voice information, recognize the voice information when the second safety condition is satisfied, and output a control instruction based on a recognition result.

### CROSS-REFERENCE TO RELATED APPLICATION

This application claims priority to and the benefit of Chinese Patent Application No. 202410361270.9, filed on Mar. 27, 2024, the entire contents of which are hereby incorporated herein by reference.

### BACKGROUND

### (a) Technical Field

The present disclosure relates to a voice control technology, and particularly, to a system and a method for controlling a vehicle from outside the vehicle.

### (b) Description of the Related Art

A voice recognition (VR) technology is widely used in an automotive field for navigation, music playback, making calls, and controlling a temperature inside a vehicle. The VR technology has improved the convenience of driver manipulation and safety while driving. For example, during the driving, a driver may set the temperature by saying “Raise the air conditioner temperature” without having to manually manipulate an air conditioner adjustment button. Therefore, it is possible to prevent a risk of safety accidents caused by the driver manipulating the air conditioner adjustment button while driving.

However, a current VR technology may be used only inside the vehicle. Manipulations from outside the vehicle may be performed using a smart key (SMK). For example, the driver may unlock a vehicle door by using the smart key. Convenience of manipulation to control the vehicle by using the VR technology from outside the vehicle is currently not available to drivers. Further, controlling the vehicle by using the VR technology from outside the vehicle may raise a new issue, such as a safety issue caused by an unidentified person manipulating the vehicle from outside the vehicle.

The information disclosed in this Background section is provided only to assist in better understanding of the background of the present disclosure, and may thus include information not included in the prior art already known to those having ordinary skill in the art to which the present disclosure pertains.

### SUMMARY

Embodiments of the present disclosure provide a system and a method for controlling a vehicle from outside the vehicle that are capable of controlling the vehicle by using a voice recognition (VR) technology from outside the vehicle while ensuring vehicle safety.

According to an embodiment, a system for controlling a vehicle from outside the vehicle is provided. The system includes a voice receiving device configured to receive voice information from outside the vehicle. The system also includes a first safety detection device configured to recognize a vehicle user by using a mobile device associated with or carried by the vehicle user and determine that a first safety condition is satisfied based on determining that the mobile device is approaching the vehicle. The system additionally includes a second safety detection device configured to compare a voiceprint of the voice information received from the voice receiving device with a pre-stored voiceprint and determine that a second safety condition is satisfied based on determining that the voiceprint of the voice information received from the voice receiving device matches the pre-stored voiceprint. The system further includes a voice control device configured to be switched from a sleep state to a wake-up state when the first safety condition is satisfied, control the voice receiving device to receive the voice information from outside the vehicle while the voice control device is in the wake-up state, recognize the voice information received from the voice receiving device when the second safety condition is satisfied, and output a control instruction to a target vehicle device based on a recognition result.

The system may further include a voice output device configured to control the voice output device to output a control result for the target vehicle device to the vehicle user.

The voice control device may further be configured to perform echo cancellation and noise reduction (ECNR) on the voice information received from the voice receiving device before the second safety condition is satisfied while the voice control device is in the wake-up state.

The voice control device may further be configured to determine whether the voice information is valid after recognizing the voice information, and output the control instruction to the target vehicle device based on determining that the voice information is valid.

The voice control device may be configured to determine that the voice information is valid based on determining that the voice information includes a target type that is intended to be set and an operation manner of the target type.

The target type may include at least one of a tailgate, a rear trunk lid, a front trunk lid, a charging door, a window, a sunroof, a vehicle interior temperature, or a steering wheel. The operation manner of the target type may include at least one of opening or closing at least one of the tailgate, the rear trunk lid, the front trunk lid, the charging door, the window, or the sunroof, raising or lowering the vehicle interior temperature, or turning or returning the steering wheel to 0 degree.

The target vehicle device may include at least one of a power tailgate monitor module, a power rear trunk lid module, a sunroof control module, a dual automatic temperature control module, a body zone control module, or a motor driven power steering module.

The mobile device may be a smart key or a terminal device on which a digital key application is installed.

The voice receiving device may be a microphone. The microphone may be installed on each of outside rearview mirrors on left and right sides of the vehicle.

The voice output device may be a speaker.

According to another embodiment, a method for controlling a vehicle from outside the vehicle is provided. The method includes recognizing, by a first safety detection device, a vehicle user by using a mobile device associated with or carried by the vehicle user. The method also includes determining, by the first safety detection device, that a first safety condition is satisfied based on determining that the mobile device is approaching the vehicle. The method further includes switching a voice control device from a sleep state to a wake-up state if the first safety condition is satisfied. The method additionally includes controlling, by the voice control device, a voice receiving device to receive voice information from outside the vehicle while the voice control device is in the wake-up state. The method further includes determining, by a second safety detection device, that a second safety condition is satisfied based on determining that a voiceprint of the voice information received from the voice receiving device matches a pre-stored voiceprint. The method also includes recognizing, by the voice control device, the voice information based on determining that the second safety condition is satisfied. The method additionally includes outputting a control instruction to a target vehicle device based on a recognition result.

The method may further include controlling, by the voice control device, a voice output device to output a control result for the target vehicle device to the vehicle user.

The method may further include performing, by the voice control device, echo cancellation and noise reduction (ECNR) on the voice information before the second safety condition is satisfied while the voice control device is in the wake-up state.

The method may further include: determining, by the voice control device, whether the voice information is valid after the voice information is recognized; and outputting, by the voice control device, the control instruction to the target vehicle device based on the recognition result in response to determining that the voice information is valid.

In the determining, by the voice control device, of whether the voice information is valid, the voice information may be determined, by the voice control device, to be valid in response to the voice information including a target type that is intended to be set and an operation manner of the target type.

The target type may include at least one of a tailgate, a rear trunk lid, a front trunk lid, a charging door, a window, a sunroof, a vehicle interior temperature, or a steering wheel, and the operation manner of the target type may include at least one of i) opening or closing at least one of the tailgate, the rear trunk lid, the front trunk lid, the charging door, the window, or the sunroof, ii) raising or lowering the vehicle interior temperature, or iii) turning or returning the steering wheel to 0 degree.

Outputting the control instruction to the target vehicle device may include outputting the control instruction to at least one of a power tailgate monitor module, a power rear trunk lid module, a sunroof control module, a dual automatic temperature control module, a body zone control module, or a motor driven power steering module.

Recognizing the vehicle user by using the mobile device associated with the vehicle user may include recognizing the vehicle user by using a smart key or a terminal device on which a digital key application is installed.

Controlling controlling the voice receiving device to receive voice information from outside the vehicle may include controlling a microphone. The microphone may be installed on at least one of outside rearview mirrors on left and right sides of the vehicle.

Controlling the voice output device may include controlling a speaker to output the control result for the target vehicle device to the vehicle user.

The present disclosure adopts the above technical approach, and may provide the following beneficial effects.

According to embodiments of the present disclosure, the application scope of the VR technology may be expanded. According to embodiments, the VR technology may be used not only inside the vehicle, but also outside the vehicle, thus increasing the convenience of manipulation. In addition, the present disclosure may ensure the safety of the VR technology. According to embodiments, the safety of the vehicle may be ensured because the vehicle device is capable of being controlled by the voice information from outside the vehicle only if both the first and second safety conditions are satisfied.

Other effects capable of being acquired or apparent from the embodiments of the present disclosure are disclosed directly or implicitly in the detailed description of the embodiments of the present disclosure. Various effects apparent from the embodiments of the present disclosure are disclosed in the detailed description described below.

### BRIEF DESCRIPTION OF THE DRAWINGS

Hereinafter, embodiments of the present disclosure are described in more detail with reference to the accompanying drawings. For clarity of description, the same components in different drawings are indicated with the same reference number. It should be noted that the drawings are only illustrative and are not necessarily drawn to scale.

FIG. 1 is a block diagram of a system for controlling a vehicle from outside the vehicle according to an embodiment of the present disclosure.

FIG. 2 is a detailed block diagram of a system for controlling a vehicle from outside the vehicle according to an embodiment of the present disclosure.

FIG. 3 is a flowchart of a method for controlling a vehicle from outside the vehicle according to an embodiment of the present disclosure.

### DETAILED DESCRIPTION

Hereinafter, embodiments of the present disclosure are described in detail. These embodiments are implemented based on a technical approach of the present disclosure, and a detailed implementation and a specific manipulation process are disclosed. However, the scope of the present disclosure is not limited to the described embodiments.

In the present disclosure, when a controller, module, component, device, element, or the like of the present disclosure is described as having a purpose or performing an operation, function, or the like, the controller, module, component, device, element, or the like should be considered herein as being “configured to” meet that purpose or to perform that operation or function. Each component, module controller, device, element, apparatus, and the like may separately embody or be included with a processor and a memory, such as a non-transitory computer readable media, as part of the apparatus.

The term “˜ unit,” “˜ module,” “˜ device,” “˜ controller,” or the like as used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

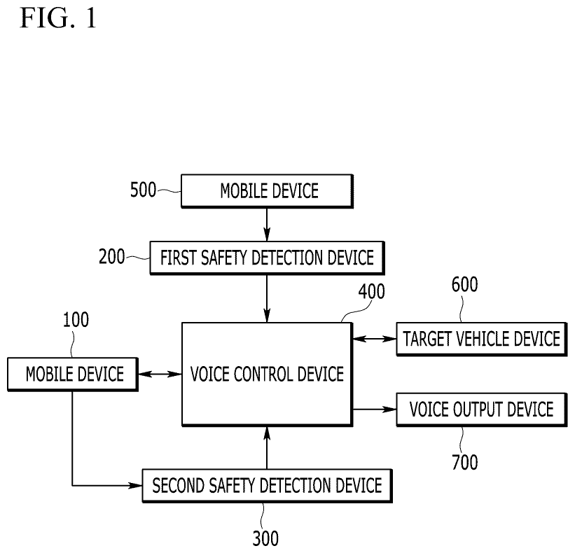

FIG. 1 is a block diagram of a system for controlling a vehicle from outside the vehicle, according to an embodiment of the present disclosure. The system for controlling the vehicle from outside the vehicle according to an embodiment of the present disclosure may include a voice receiving device 100, a first safety detection device 200, a second safety detection device 300, and a voice control device 400.

The voice receiving device 100 may receive voice information from outside the vehicle. The first safety detection device 200 may recognize a vehicle user by using a mobile device 500 associated with (or carried by) the vehicle user, determine that the vehicle user approaches the vehicle if the mobile device 500 is detected as approaching the vehicle, and determine that a first safety condition is thus satisfied. The second safety detection device 300 may compare a voiceprint of the voice information received from the voice receiving device 100 with a pre-stored voiceprint. The second safety detection device 300 may detect that the vehicle user is a user having control authority and may determine that a second safety condition is thus satisfied if the voiceprint of the voice information received from the voice receiving device 100 matches one of the pre-stored voiceprints. The voice control device 400 may be switched from a sleep state to a wake-up state if the first safety condition is satisfied, and control the voice receiving device 100 to receive the voice information from outside the vehicle while the voice control device 400 is in the wake-up state. The voice control device 400 may recognize the voice information received from the voice receiving device 100 if the second safety condition is satisfied and may output a control instruction to a corresponding target vehicle device 600 based on the recognition result.

In this way, according to an embodiment of the present disclosure, safety of the vehicle may be ensured because the vehicle device is capable of being controlled by the voice information from outside the vehicle only if both the first and second safety conditions are satisfied. For example, the first safety detection device 200 may detect whether the vehicle user arrives at a designated location (i.e., around the vehicle). The first safety detection device 200 may recognize the vehicle user by using the mobile device 500 associated with or carried by the user and may consider a location of the mobile device 500 as a location of the vehicle user. After the vehicle user is detected to arrive at the designated location, the second safety detection device 300 may use the stored voiceprint to detect whether the recognized vehicle user has wider control authority by using the mobile device 500. Verification of the control authority may require that the voice matches the stored voiceprint. For example, if a child is recognized as carrying the mobile device (e.g., smart key), the child may be unable to control a vehicle function through voice input because the voice does not match the stored voiceprint. Accordingly, the system according to an embodiment of the present disclosure may prevent a safety problem that may occur if a child manipulates the vehicle from outside the vehicle.

The system for controlling the vehicle from outside the vehicle may further include a voice output device 700. The voice control device 400 may control the voice output device 700 to output a control result for the target vehicle device 600 to the vehicle user. Therefore, the vehicle user may recognize whether the target vehicle device is completely controlled through a voice feedback.

As an example, the voice control device 400 may perform echo cancellation and noise reduction (ECNR) on the voice information received from the voice receiving device 100 before the second safety condition is satisfied while the voice control device 400 is in the wake-up state. The vehicle user may be separated from the voice receiving device 100 by a certain distance, and ambient noise may be present. The voice control device 400 may thus adjust the voice information received from the voice receiving device 100. Therefore, the voice control device 400 may clearly filter the voice information even if the vehicle user is far from the vehicle and the ambient noise is loud, which may be advantageous for the voice control device 400 to perform the voiceprint comparison of the voice information and recognize the voice information in a subsequent process.

The voice control device 400 may determine whether the voice information is valid after the voice control device 400 recognizes the voice information. The voice control device 400 may output a control instruction to the corresponding target vehicle device 600 based on the recognition result if the voice information is determined to be valid by the voice control device 400. On the other hand, if the voice information is determined to be invalid by the voice control device 400, the voice control device 400 does not output any control instruction.

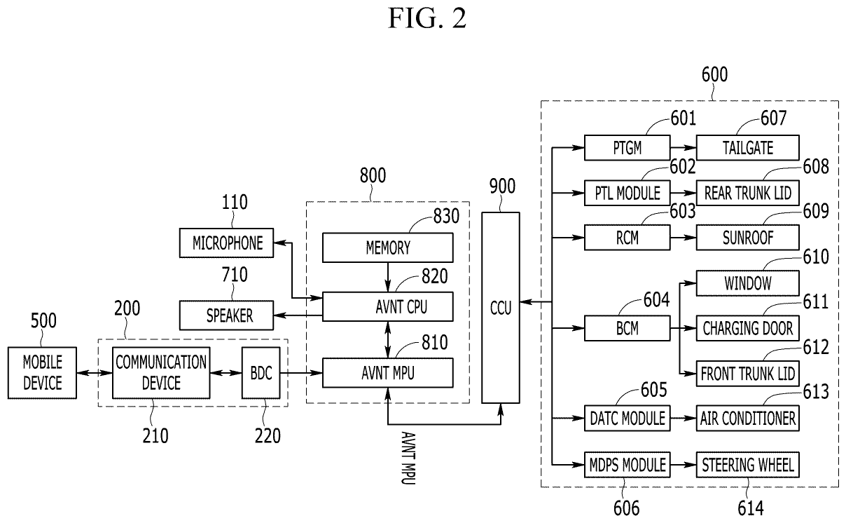

FIG. 2 is a detailed block diagram of a system for controlling a vehicle from outside the vehicle according to an embodiment of the present disclosure.

Referring to FIGS. 1 and 2, the voice receiving device 100 may be a microphone 110. The microphones 110 may be installed on each of outside rearview mirrors on left and right sides of the vehicle. The outside rearview mirror may provide a space for mounting the microphone 110 that is not affected by a weather condition. Simultaneously, a position of the outside rearview mirror of the vehicle that protrudes from a vehicle outline may ensure the microphone 110 to effectively receive a voice outside the vehicle.

The first safety detection device 200 may include a communication device 210 and a body domain controller (BDC) 220 installed in the vehicle. As an example, while the vehicle is locked, the BDC 220 may control the communication device 210 to transmit a signal to search for the mobile device 500 within a predetermined search range. If the vehicle user carries the mobile device 500 and enters the search range, the mobile device 500 may receive the signal from the communication device 210. After receiving the signal from the communication device 210, the mobile device 500 may transmit a signal to the BDC 220 through the communication device 210. If the BDC 220 receives the signal from the mobile device 500 through the communication device 210, the BDC 220 may recognize the vehicle user and determine that the vehicle user enters the search range, i.e., that the vehicle user approaches the vehicle. After the vehicle user is determined as approaching the vehicle by the BDC 220, the BDC 220 may transmit a wake-up signal to the voice control device 400, thereby causing the voice control device 400 to be switched from the sleep state to the wake-up state.

For example, the communication device 210 may be any one of an ultra-wideband communication (UWB) antenna, a Bluetooth low energy (BLE) antenna, a wireless power consortium (WPC) antenna, or near field communication (NFC) antenna. Correspondingly, the mobile device 500 may be any device capable of communicating with the BDC 220 through the communication device 210. For example, the mobile device 500 may be a terminal device on which a smart key or a digital key (DK) application is installed. For example, the mobile device 500 may be a smartphone on which a DK2.0 application is installed.

The second safety detection device 300 and the voice control device 400 may be implemented through an audio, video, navigation & telecommunication (AVNT) 800. For example, the AVNT 800 may include a microcontroller unit (MCU) 810, a central processing unit (CPU) 820 and a memory 830 installed in the AVNT 800.

The BDC 220 may transmit the wake-up signal to the AVNT MCU 810. The AVNT 800 may wake up if the AVNT MCU 810 receives the wake-up signal from the BDC 220. Accordingly, the AVNT CPU 820 may wake up. After the AVNT CPU 820 wakes up, the AVNT CPU 820 may control the microphone 110 to be operated. For example, the AVNT CPU 820 may transmit an activation signal to the microphone 110, and the microphone 110 may receive the activation signal and then receive the voice information from outside the vehicle.

If the AVNT CPU 820 receives the voice information from outside the vehicle from the microphone 110, the AVNT CPU 820 may perform the ECNR on the voice information received from the microphone 110. The AVNT CPU 820 may then compare the ENCR-processed voiceprint of the voice information with the pre-stored voiceprint (for example, pre-stored in the memory 830). The AVNT CPU 820 may recognize the voice information received from the microphone 110 if the voiceprint of the voice information received from the microphone 110 matches one of the pre-stored voiceprints.

When the AVNT CPU 820 recognizes the voice information, the AVNT CPU 820 may determine whether the voice information is valid. If the voice information is determined to be valid by the AVNT CPU 820, the AVNT CPU 820 may transmit the recognition result to the AVNT MCU 810, and the AVNT MCU 810 may output the control instruction to the corresponding target vehicle device 600 based on the recognition result. If the voice information is determined to be invalid by the AVNT CPU 820, the AVNT CPU 820 does not transmit the recognition result to the AVNT MCU 810.

In an embodiment, the AVNT CPU 820, i.e., voice control device 400, may determine that the voice information is valid if the voice information includes a target type that is intended to be set and an operation manner of the target type.

The target type may include at least one of a rear trunk lid, a front trunk lid, a charging door, a window, a sunroof, a vehicle interior temperature, and/or a steering wheel. The operation manner of the target type may include at least one of opening or closing at least one of the rear trunk lid, the front trunk lid, the charging door, the window, or the sunroof, raising or lowering the vehicle interior temperature, or turning the steering wheel to 0 degree. For example, valid voice information may be “Open the rear trunk lid”, “Turn up the temperature”, or the like.

The target vehicle device 600 may include respective vehicle electronic control unit (ECU) for controlling the target type. The AVNT MCU 810 and the respective ECU may communicate with each other by using a communication control unit (CCU) 900.

The vehicle ECU may include at least one of a power tail gate monitor (PTGM) module 601, a power trunk lid (PTL) module 602, a roof control module (RCM) 603, a body zone control module (BCM) 604, a dual automatic temperature control (DATC) module 605, a motor driven power steering (MDPS) module 606, or the like.

If the vehicle is a sedan type passenger car, a rear trunk lid 608 may be installed at the rear of the vehicle, and the PTL module 602 may control the opening or closing of the rear trunk lid 608. If the vehicle is another type of vehicle, such as a sports utility vehicle (SUV), a tailgate 607 may be installed at the rear of the vehicle, and the PTGM 601 may control the opening or closing of the tailgate 607. The RCM 603 may control the opening or closing of a sunroof 609. The BCM 604 may control the opening or closing of a window 610, a charging door 611, and a front trunk lid 612. The DATC module 605 may control the temperature, that is, an operation of a vehicle air conditioner 613. The MDPS module 606 may control return of a steering wheel 614.

Therefore, the target vehicle device 600 corresponding to the target type in the voice information may be operated in an operating manner in the voice information.

The voice output device 700 may be a speaker 710. The speaker 710 may be a speaker of a virtual engine sound system (VESS). The speaker 710 may be installed outside the vehicle to improve voice transmission efficiency. Therefore, the vehicle ECU that receives the control instruction from the AVNT MCU 810 may transmit the control result for the vehicle ECU to the AVNT MCU 810, and the AVNT CPU 820 may transmit an audio output signal indicating the control result to the speaker. If the speaker receives the audio output signal from the AVNT CPU 820, the speaker may output audio to inform the user of the control result for the target vehicle device 600.

In addition, the BDC 220, the AVNT MCU 810, the AVNT CPU 820, and the plurality of vehicle ECUs may communicate with each other through a controller area network (CAN). The microphone 110 and the AVNT CPU 820, the AVNT CPU 820 and the speaker 710, and the plurality of vehicle ECUs and corresponding actuators may be electrically connected with each other in a wired manner.

In the above-mentioned specific embodiment of the present disclosure, the speaker 710 of the conventional VESS and the AVNT 800 may be shared, and the AVNT CPU 820 may have improved control logic to thus perform the ENCR processing, the voiceprint comparison, and the voice recognition. Therefore, only the microphone may be additionally installed in conventional vehicle components. Therefore, cost of additional components may be limited, thus achieving a purpose of adding minimum additional cost.

A method for controlling the vehicle from outside the vehicle may be further provided according to another embodiment of the present disclosure. The method may include: recognizing, by the first safety detection device 200, the vehicle user by using the mobile device 500 carried by the vehicle user, determining that the vehicle user approaches the vehicle if the mobile device 500 is detected as approaching the vehicle, and determining that the first safety condition is satisfied; switching the voice control device 400 from the sleep state to the wake-up state if the first safety condition is satisfied, and receiving, by the voice receiving device 100, the voice information from outside the vehicle under the control of the voice control device 400 while the voice control device 400 is in the wake-up state; and comparing, by the second safety detection device 300, the voiceprint of the voice information received from the voice receiving device 100 with the pre-stored voiceprint, determining that the vehicle user carrying the smart key 500 is the vehicle user having the control authority if the voiceprint of the voice information received from the voice receiving device 100 matches one of the pre-stored voiceprints, and determining that the second safety condition is thus satisfied.

As an example, while the voice control device 400 is in the wake-up state, the ECNR may be performed, by the voice control device 400, on the received voice information before the second safety condition is satisfied.

The voice information received from the voice receiving device 100 may be recognized by the voice control device 400 if the second safety condition is satisfied, and the control instruction may be output to the corresponding target vehicle device 600 based on the recognition result.

For example, after the voice information is recognized by the voice control device 400, whether the voice information is valid may be determined by the voice control device 400, and if the voice information is determined to be valid, the control instruction may be output by the voice control device 400 to the corresponding target vehicle device 600 based on the recognition result. In detail, the voice information may be determined to be valid if the voice information includes the target type that is intended to be set and the operation manner of the target type.

In addition, the voice control device 400 may control the voice output device 700 to output the control result for the target vehicle device to the vehicle user.

In detail, the voice receiving device 100 may be the microphone 110, and the first safety detection device 200 may include the communication device 210 and the BDC 220, installed in the vehicle. The second safety detection device 300 and the voice control device 400 may be implemented through the AVNT 800. The voice output device 700 may be the speaker 710.

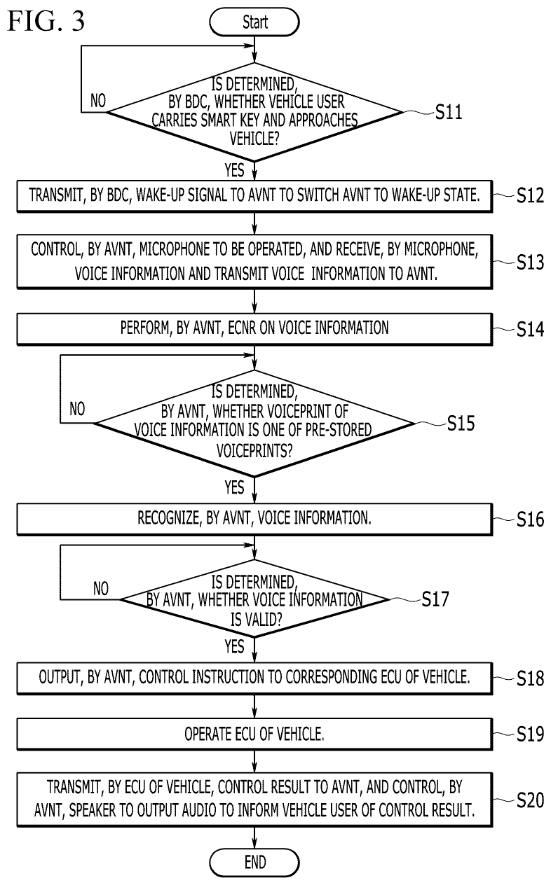

FIG. 3 is a flowchart of a method for controlling a vehicle from outside the vehicle according to an embodiment of the present disclosure. As shown in FIG. 3, the BDC 220 may determine whether the vehicle user carries the mobile device (e.g., smart key) and approaches the vehicle at step or operation S11. The BDC 220 may transmit the wake-up signal to the AVNT 800 to switch the AVNT 800 from the sleep state to the wake-up state at step or operation S12 if the vehicle user is detected by the BDC 220 to carry the smart key and approach the vehicle (“YES” in the step or operation S11).

After the AVNT 800 wakes up, the AVNT 800 may control the microphone 110 to be operated. The microphone 110 may receive the voice information sent from the vehicle user and transmit the voice information to the AVNT 800 if the vehicle user sends the voice information from a location close to the vehicle at step or operation S13.

The AVNT 800 may perform the ECNR on the voice information received from the microphone 110 at step or operation S14. In addition, the AVNT 800 may compare the voiceprint of the ECNR-processed voice information with the voiceprint pre-stored in the AVNT 800 and may determine whether the voiceprint of the voice information received from the microphone 110 matches one of the pre-stored voiceprints at step or operation S15. The AVNT CPU 800 may recognize the voice information received from the microphone 110 at step or operation S16 if the voiceprint of the voice information received from the microphone 110 matches one of the pre-stored voiceprints “YES” in the step or operation S15).

After the AVNT CPU 820 recognizes the voice information, the AVNT 800 may determine whether the voice information is valid at step or operation S17, and the AVNT 800 may output the control instruction to the corresponding target vehicle device 600, specifically, to the vehicle ECU based on the recognition result at step or operation S18 if the AVNT 800 determines that the voice information is valid (“YES” in the step or operation S17).

The ECU of the vehicle may be operated based on the received control instruction at step or operation S19. In addition, the ECU of the vehicle may transmit the control result to the AVNT 800, and the AVNT 800 may control the speaker 710 to output the audio to inform the vehicle user of the control result for the target vehicle device at step or operation S20.

The application range of the voice recognition (VR) technology may be expanded using the system and the method for controlling the vehicle from outside the vehicle according to the embodiments of the present disclosure. The VR technology may be used not only inside the vehicle, but also outside the vehicle, thus increasing the convenience of manipulation.

In addition, the system and the method for controlling the vehicle from outside the vehicle according to the embodiments of the present disclosure may ensure the safety of the VR technology. The safety of the vehicle may be ensured because the vehicle device is capable of being controlled by the voice information from outside the vehicle only if both the first and the second safety conditions are satisfied.

In addition, in the system and the method for controlling the vehicle from outside the vehicle according to the embodiments of the present disclosure, the speaker of the conventional VESS and the AVNT may be shared, and the AVNT CPU may have the improved control logic to thus perform the ENCR processing, the voiceprint comparison, and the voice recognition. Therefore, only the microphone may be additionally installed in the conventional vehicle. Therefore, the additional cost may be limited, thus achieving the purpose of adding minimum additional cost.

The various embodiments of the present disclosure describe representative aspects of the present disclosure rather than enumerating all possible combinations thereof, and also the contents described in the various embodiments may be applied alone or in combination of two or more.

The description of the embodiments hereinabove is intended only to describe the technical approach of the present disclosure, should not be considered complete, nor is it intended to limit the present disclosure to any precise form described herein. It is apparent that those having ordinary skill in the art may make various modifications and changes to the embodiments disclosed above. The selection and description of the embodiments are intended to assist those having ordinary skill in the art to interpret the specific principles of the present disclosure and their practical applications to thus utilize each embodiment of the present disclosure and its different alternatives and modifications. The scope of the present disclosure may be defined by the appended claims and their equivalents.

What is claimed is:

1. A system for controlling a vehicle from outside the vehicle, the system comprising:
a voice receiving device configured to receive voice information from outside the vehicle;
a first safety detection device configured to i) recognize a vehicle user by using a mobile device associated with the vehicle user and ii) determine that a first safety condition is satisfied based on determining that the mobile device is approaching the vehicle;
a second safety detection device configured to i) compare a voiceprint of the voice information received from the voice receiving device with a pre-stored voiceprint and ii) determine that a second safety condition is satisfied based on determining that the voiceprint of the voice information received from the voice receiving device matches the pre-stored voiceprint; and
a voice control device configured to:
be switched from a sleep state to a wake-up state when the first safety condition is satisfied,
control the voice receiving device to receive the voice information from outside the vehicle while the voice control device is in the wake-up state,
recognize the voice information received from the voice receiving device when the second safety condition is satisfied, and
output a control instruction to a target vehicle device based on a recognition result.

2. The system of claim 1, further comprising a voice output device configured to control the voice output device to output a control result for the target vehicle device to the vehicle user.

3. The system of claim 1, wherein the voice control device is further configured to perform echo cancellation and noise reduction (ECNR) on the voice information received from the voice receiving device before the second safety condition is satisfied while the voice control device is in the wake-up state.

4. The system of claim 1, wherein the voice control device is further configured to:
determine whether the voice information is valid after recognizing the voice information; and
output the control instruction to the target vehicle device based on determining that the voice information is valid.

5. The system of claim 4, wherein the voice control device is configured to determine that the voice information is valid based on determining that the voice information includes a target type that is intended to be set and an operation manner of the target type.

6. The system of claim 5, wherein:
the target type includes at least one of a tailgate, a rear trunk lid, a front trunk lid, a charging door, a window, a sunroof, a vehicle interior temperature, or a steering wheel; and
the operation manner of the target type includes at least one of i) opening or closing at least one of the tailgate, the rear trunk lid, the front trunk lid, the charging door, the window, or the sunroof, ii) raising or lowering the vehicle interior temperature, or iii) turning or returning the steering wheel to 0 degree.

7. The system of claim 1, wherein the target vehicle device includes at least one of a power tailgate monitor module, a power rear trunk lid module, a sunroof control module, a dual automatic temperature control module, a body zone control module, or a motor driven power steering module.

8. The system of claim 1, wherein the mobile device is a smart key or a terminal device on which a digital key application is installed.

9. The system of claim 1, wherein the voice receiving device is a microphone, and wherein the microphone is installed on at least one of outside rearview mirrors on left and right sides of the vehicle.

10. The system of claim 2, wherein the voice output device is a speaker.

11. A method for controlling a vehicle from outside the vehicle, the method comprising:
recognizing, by a first safety detection device, a vehicle user by using a mobile device associated with the vehicle user;
determining, by the first safety detection device, that a first safety condition is satisfied based on determining that the mobile device is approaching the vehicle;
switching a voice control device from a sleep state to a wake-up state based on determining that the first safety condition is satisfied;
controlling, by the voice control device, a voice receiving device to receive voice information from outside the vehicle while the voice control device is in the wake-up state;
determining, by a second safety detection device, that a second safety condition is satisfied based on determining that a voiceprint of the voice information received from the voice receiving device matches a pre-stored voiceprint;
recognizing, by the voice control device, the voice information based on determining that the second safety condition is satisfied; and
outputting a control instruction to a target vehicle device based on a recognition result.

12. The method of claim 11, further comprising controlling, by the voice control device, a voice output device to output a control result for the target vehicle device to the vehicle user.

13. The method of claim 11, further comprising performing, by the voice control device, echo cancellation and noise reduction (ECNR) on the voice information before the second safety condition is satisfied while the voice control device is in the wake-up state.

14. The method of claim 11, wherein further comprising:
determining, by the voice control device, whether the voice information is valid after the voice information is recognized; and
outputting, by the voice control device, the control instruction to the target vehicle device based on the recognition result in response to determining that the voice information is valid.

15. The method of claim 14, wherein determining, by the voice control device, whether the voice information is valid includes determining that the voice information is valid in response to determining that the voice information includes a target type that is intended to be set and an operation manner of the target type.

16. The method of claim 15, wherein:
the target type includes at least one of a tailgate, a rear trunk lid, a front trunk lid, a charging door, a window, a sunroof, a vehicle interior temperature, or a steering wheel; and
the operation manner of the target type includes at least one of i) opening or closing at least one of the tailgate, the rear trunk lid, the front trunk lid, the charging door, the window, or the sunroof, ii) raising or lowering the vehicle interior temperature, or iii) turning or returning the steering wheel to 0 degree.

17. The method of claim 11, wherein outputting the control instruction to the target vehicle device includes outputting the control instruction to at least one of a power tailgate monitor module, a power rear trunk lid module, a sunroof control module, a dual automatic temperature control module, a body zone control module, or a motor driven power steering module.

18. The method of claim 11, wherein recognizing the vehicle user by using the mobile device associated with the vehicle user includes recognizing the vehicle user by using a smart key or a terminal device on which a digital key application is installed.

19. The method of claim 11, wherein controlling controlling the voice receiving device to receive voice information from outside the vehicle includes controlling a microphone, wherein the microphone is installed on at least one of outside rearview mirrors on left and right sides of the vehicle.

20. The method of claim 12, wherein controlling the voice output device includes controlling a speaker to output the control result for the target vehicle device to the vehicle user.
